(19) United States
(12) Patent Application Publication
(10) Pub. No.: US 2015/0112526 A1
(43) Pub. Date: Apr. 23, 2015

(54) VEHICLE SYSTEM AND METHOD FOR AT-HOME ROUTE PLANNING

(71) Applicant: Ford Global Technologies, LLC, Dearborn, MI (US)

(72) Inventors: Douglas Raymond MARTIN, Canton, MI (US); Kenneth James MILLER, Canton, MI (US)

(73) Assignee: Ford Global Technologies, LLC, Dearborn, MI (US)

(21) Appl. No.: 14/059,482

(22) Filed: Oct. 22, 2013

(51) Int. Cl. G01C 21/36

(52) U.S. Cl. CPC G01C 21/3697
USPC 701/22

(57) ABSTRACT

A method according to an exemplary aspect of the present disclosure includes, among other things, pre-planning a route of a vehicle on a computing device separate from the vehicle including selecting a battery mode for operating the vehicle during each stage of the route and displaying a battery state of charge for each stage of the route. The vehicle is controlled based on route information associated with the pre-planned route.

### TECHNICAL FIELD

This disclosure relates to electrified vehicles, and more particularly, but not exclusively, to a vehicle system and method that provides user control over battery mode operation during each stage of a pre-planned route.

### BACKGROUND

Hybrid electric vehicles (HEV's), plug-in hybrid electric vehicles (PHEV's), battery electric vehicles (BEV's), fuel cell vehicles and other known electrified vehicles differ from conventional motor vehicles in that they are powered by one or more electric machines (i.e., electric motors and/or generators) instead of or in addition to an internal combustion engine. High voltage current is typically supplied by one or more batteries that store electrical power for powering the electric machine(s).

Electrified vehicles have become increasingly popular in recent years because of their potential for reduced emissions and increased fuel efficiency. As popularity has increased, user preferences and demands have become more sophisticated. For example, many electrified vehicle customers have expressed a desire for greater control over when the vehicle operates in an electric-only mode (i.e., driven only by the driving power of an electric machine) and a battery saver mode (i.e., driven with the aid of a conventional internal combustion engine). It may be desirable for a customer to determine when the electrified vehicle transitions between battery modes during operation.

### SUMMARY

A method according to an exemplary aspect of the present disclosure includes, among other things, pre-planning a route of a vehicle on a computing device separate from the vehicle including selecting a battery mode for operating the vehicle during each stage of the route and displaying a battery state of charge for each stage of the route. The vehicle is controlled based on route information associated with the pre-planned route.

In a further non-limiting embodiment of the foregoing method, the step of pre-planning includes accessing a software application or a website on the computing device.

In a further non-limiting embodiment of either of the foregoing methods, the step of selecting the battery mode includes selecting an electric only EV mode for a first stage of the route, selecting a battery saver BS mode for a second stage of the route and selecting a battery charge mode for a third stage of the route.

In a further non-limiting embodiment of any of the foregoing methods, the step of displaying the battery state of charge includes generating a graph that plots the battery state of charge versus distance.

In a further non-limiting embodiment of any of the foregoing methods, the step of displaying the battery state of charge includes displaying a bar that rises above each stage of the route, the bar numerically indicating the battery state of charge.

In a further non-limiting embodiment of any of the foregoing methods, the step of pre-planning the route includes displaying a map and selecting a starting point and a destination on the map for creating the pre-planned route.

In a further non-limiting embodiment of any of the foregoing methods, the method includes entering an initial battery state of charge and fuel level of the vehicle prior to the step of selecting the battery mode.

In a further non-limiting embodiment of any of the foregoing methods, the method includes the step of automatically generating a return route based on the pre-planned route created during the step of pre-planning.

In a further non-limiting embodiment of any of the foregoing methods, the method includes the step of adjusting the battery mode associated with each stage of the route in response to the step of displaying the battery state of charge indicating insufficient charge to complete the route.

In a further non-limiting embodiment of any of the foregoing methods, the vehicle is an autonomously driven electrified vehicle.

A method according to another exemplary aspect of the present disclosure includes, among other things, pre-planning a route of a vehicle, selecting battery mode transition points along each stage of the route, automatically generating a return route of the vehicle after the steps of pre-planning and selecting and controlling the vehicle during the route and the return route based on route information that includes the battery mode transition points.

In a further non-limiting embodiment of the foregoing method, the method includes entering an initial battery state of charge and fuel level of the vehicle prior to the step of selecting.

In a further non-limiting embodiment of either of the foregoing methods, the step of selecting includes choosing between an electric only EV mode, a battery saver BS mode and a custom mode for each stage of the route.

In a further non-limiting embodiment of any of the foregoing methods, the method includes the step of displaying a battery state of charge for each stage of the route and the return route.

In a further non-limiting embodiment of any of the foregoing methods, the method includes the step of downloading the route information onto the vehicle prior to the step of controlling.

A vehicle system according to another exemplary aspect of the present disclosure includes, among other things, a computing device separate from a vehicle and configured to select battery mode transition points and display a battery state of charge for each stage of a route. A vehicle communication system is located on-board the vehicle and configured to download route information that includes the battery mode transition points from the computing device. A vehicle controller is configured to operate the vehicle based on the route information.

In a further non-limiting embodiment of the foregoing system, the computing device is a smart device or a personal computer.

In a further non-limiting embodiment of either of the foregoing systems, the vehicle communication system includes a transceiver for communicating with the computing device.

In a further non-limiting embodiment of any of the foregoing systems, a navigation system is in communication with the vehicle communication system.

In a further non-limiting embodiment of any of the foregoing systems, the vehicle system is part of an autonomously driven electrified vehicle.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a powertrain of an electrified vehicle.

FIG. 2 is a highly schematic depiction of a vehicle system associated with an electrified vehicle.

FIGS. 3, 4, 5, 6, 7, 8 and 9 schematically illustrate a method for operating an electrified vehicle using the vehicle system of FIG. 2.

### DETAILED DESCRIPTION

This disclosure relates to a vehicle system and method for at-home route planning and controlling an electrified vehicle based on the pre-planned route. The proposed system and method is configured to permit a customer to plan, analyze, select and control a battery mode of the electrified vehicle during each stage of a pre-planned route. A display of a battery state of charge for each stage of the route may be displayed to the user. This display may then be used to determine whether sufficient battery power is available for utilizing the selected battery modes along the route, or whether the battery mode or the route itself will need to be modified. These and other features are discussed in greater detail herein.

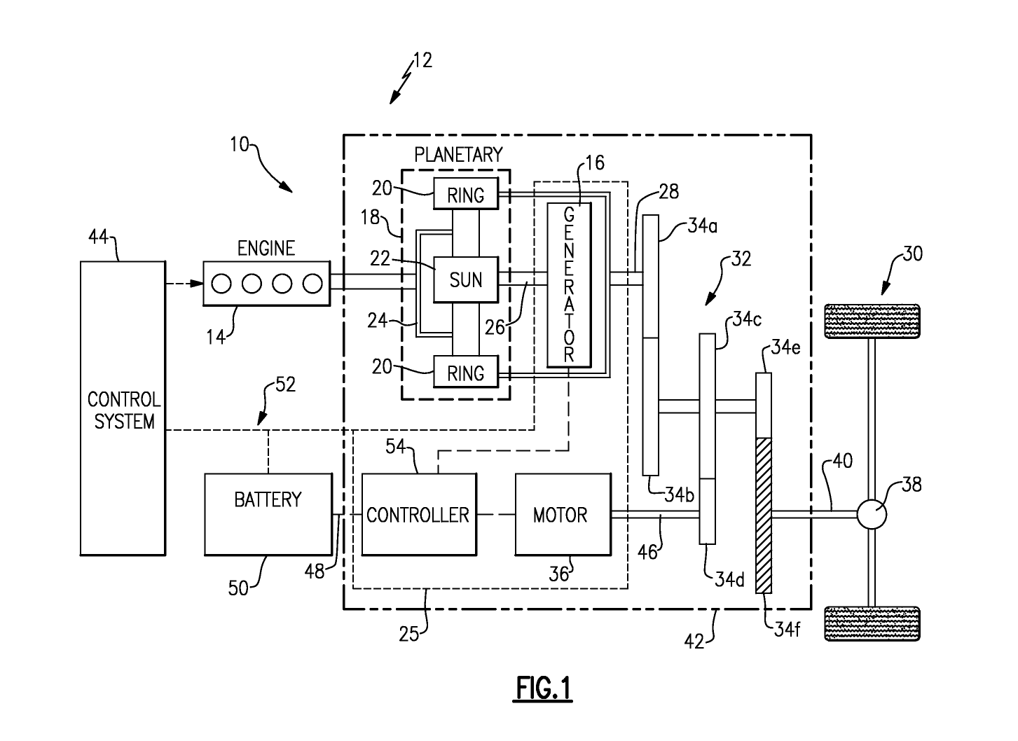

FIG. 1 schematically illustrates a powertrain 10 for an electrified vehicle 12, such as a HEV. Although depicted as a HEV, it should be understood that the concepts described herein are not limited to HEV's and could extend to other electrified vehicles, including but not limited to, PHEV's, BEV's, and fuel cell vehicles. The electrified vehicle 12 may be operated by a user or could be an autonomously driven electrified vehicle.

In one embodiment, the powertrain 10 is a powersplit system that employs a first drive system that includes a combination of an engine 14 and a generator 16 (i.e., a first electric machine) and a second drive system that includes at least a motor 36 (i.e., a second electric machine), the generator 16 and a battery 50. For example, the motor 36, the generator 16 and the battery 50 may make up an electric drive system 25 of the powertrain 10. The first and second drive systems generate torque to drive one or more sets of vehicle drive wheels 30 of the electrified vehicle 12, as discussed in greater detail below.

The engine 14, such as an internal combustion engine, and the generator 16 may be connected through a power transfer unit 18. In one non-limiting embodiment, the power transfer unit 18 is a planetary gear set. Of course, other types of power transfer units, including other gear sets and transmissions, may be used to connect the engine 14 to the generator 16. The power transfer unit 18 may include a ring gear 20, a sun gear 22 and a carrier assembly 24. The generator 16 is driven by the power transfer unit 18 when acting as a generator to convert kinetic energy to electrical energy. The generator 16 can alternatively function as a motor to convert electrical energy into kinetic energy, thereby outputting torque to a shaft 26 connected to the carrier assembly 24 of the power transfer unit 18. Because the generator 16 is operatively connected to the engine 14, the speed of the engine 14 can be controlled by the generator 16.

The ring gear 20 of the power transfer unit 18 may be connected to a shaft 28 that is connected to vehicle drive wheels 30 through a second power transfer unit 32. The second power transfer unit 32 may include a gear set having a plurality of gears 34A, 34B, 34C, 34D, 34E, and 34F. Other power transfer units may also be suitable. The gears 34A-34F transfer torque from the engine 14 to a differential 38 to provide traction to the vehicle drive wheels 30. The differential 38 may include a plurality of gears that enable the transfer of torque to the vehicle drive wheels 30. The second power transfer unit 32 is mechanically coupled to an axle 40 through the differential 38 to distribute torque to the vehicle drive wheels 30.

The motor 36 can also be employed to drive the vehicle drive wheels 30 by outputting torque to a shaft 46 that is also connected to the second power transfer unit 32. In one embodiment, the motor 36 and the generator 16 are part of a regenerative braking system in which both the motor 36 and the generator 16 can be employed as motors to output torque. For example, the motor 36 and the generator 16 can each output electrical power to a high voltage bus 48 and the battery 50. The battery 50 may be a high voltage battery that is capable of outputting electrical power to operate the motor 36 and the generator 16. Other types of energy storage devices and/or output devices can also be incorporated for use with the electrified vehicle 12.

The motor 36, the generator 16, the power transfer unit 18, and the power transfer unit 32 may generally be referred to as a transaxle 42, or transmission, of the electrified vehicle 12. Thus, when a driver selects a particular shift position, the transaxle 42 is appropriately controlled to provide the corresponding gear for advancing the electrified vehicle 12 by providing traction to the vehicle drive wheels 30.

The powertrain 10 may additionally include a control system 44 for monitoring and/or controlling various aspects of the electrified vehicle 12. For example, the control system 44 may communicate with the electric drive system 25, the power transfer units 18, 32 or other components to monitor and/or control the electrified vehicle 12. The control system 44 includes electronics and/or software to perform the necessary control functions for operating the electrified vehicle 12. In one embodiment, the control system 44 is a combination vehicle system controller and powertrain control module (VSC/PCM). Although it is shown as a single hardware device, the control system 44 may include multiple controllers in the form of multiple hardware devices, or multiple software controllers within one or more hardware devices.

A controller area network (CAN) 52 allows the control system 44 to communicate with the transaxle 42. For example, the control system 44 may receive signals from the transaxle 42 to indicate whether a transition between shift positions is occurring. The control system 44 may also communicate with a battery control module of the battery 50, or other control devices.

Additionally, the electric drive system 25 may include one or more controllers 54, such as an inverter system controller (ISC). The controller 54 is configured to control specific components within the transaxle 42, such as the generator 16 and/or the motor 36, such as for supporting bidirectional power flow. In one embodiment, the controller 54 is an inverter system controller combined with a variable voltage converter (ISC/VVC).

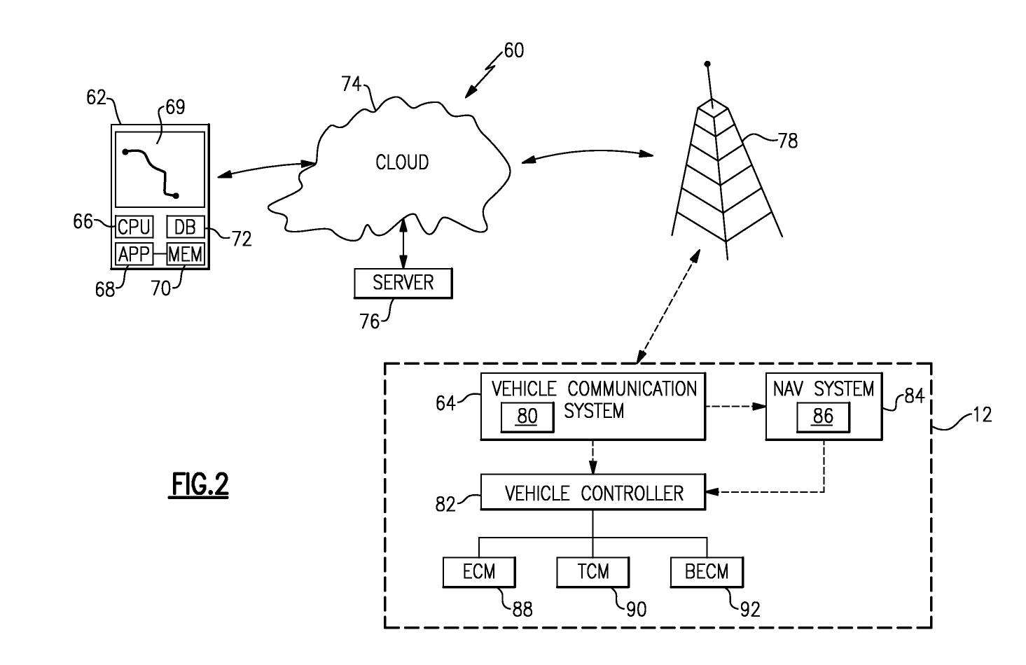

FIG. 2 illustrates a highly schematic block diagram of a vehicle system 60 that may be used to program and/or control an electrified vehicle, such as the electrified vehicle 12 of FIG. 1. The vehicle system 60 includes a vehicle communication system 64 capable of sending/receiving information to/from other components, such as a computing device 62 that can be operated by a user (i.e., the owner/operator of the electrified vehicle). In one embodiment, the computing device 62 is located separately from the electrified vehicle 12 and the vehicle communication system 64 is part of, or on-board of, the electrified vehicle 12.

The computing device 62 may be in the form of a personal computer, a tablet, a smartphone or any other portable computing device. The computing device 62 may be equipped with a central processing unit (CPU) 66 capable of executing a software application (APP) 68 loaded in program memory 70. A database 72 locally stores user data on the computing device 62. The user may enter information on the computing device 62 using the APP 68 or by accessing a website or series of websites (such as www.syncmyride.com, for example) via a web browser. The computing device 62 may additionally include a display 69 for displaying information to the user.

The user data entered onto the computing device 62 may be transferred over the cloud 74 (i.e., the internet) to a server 76. This data may be communicated from the computing device 62 via a wired, wireless or a cellular network. The server 76 identifies, collects and stores the user data from the computing device 62 for later validation purposes. Upon an authorized request, the data may be subsequently transmitted to the vehicle communication system 64 via a cellular tower 78 or some other known communication technique.

In another embodiment, the data entered on the computing device 62 could be downloaded to the electrified vehicle 12 via a memory device, such as a universal serial bus (USB) flash drive. It should be understood that the user data may be downloaded onto the electrified vehicle 12 in any manner.

As explained in greater detailed below, the data transmitted to the vehicle communication system 64 can be used to control the operation of the electrified vehicle 12 in some manner. In one non-limiting embodiment, a user may utilize the computing device 62 to pre-plan a route of the electrified vehicle 12. As discussed in greater detail below, the user may select a route and select a battery mode for operating the electrified vehicle 12 during each stage of the selected route. For example, the electrified vehicle 12 may be operated by transitioning between specific battery modes (i.e., electric only EV mode or battery saver BS mode) during each stage of the pre-planned route as defined by the user on the computing device 62.

In one embodiment, the vehicle communication system 64 includes the SYNC system manufactured by THE FORD MOTOR COMPANY. However, this disclosure is not limited to this exemplary system. The vehicle communication system 64 may include a transceiver 80 for bidirectional communication with the cellular tower 78 or other device. For example, the transceiver 80 can receive data from the server 76 or can communicate data back to the server 76 via the cellular tower 78. Although not necessarily shown or described in this highly schematic embodiment, the vehicle communication system 64 could include numerous other components within the scope of this disclosure.

The data received by the transceiver 80 (originally entered on the computing device 62) may be communicated to a vehicle controller 82. In one embodiment, the vehicle controller 82 is programmed with the necessary hardware and software for controlling various systems of the electrified vehicle 12. For example, information related to the pre-planned route prepared by the user on the computing device 62 may be communicated to and displayed by a navigation system 84. The navigation system 84 could include an interface 86 located inside the electrified vehicle 12 for displaying the pre-planned route, among other information. A user may interact with the interface 86 via a touch screen, buttons, audible speech, speech synthesis, etc.

The data received by the vehicle controller 82 may additionally be used to control an engine control module (ECM) 88, a transmission control module (TCM) 90 and/or a battery electronic control module (BECM) 92 of the battery 50 (see FIG. 1). In one non-limiting embodiment, in combination with the navigation system 84, the user data received by the vehicle controller 82 is used to control a battery mode of the battery 50 during operation of the electrified vehicle 12 for each stage of the pre-planned route. For example, the user data would indicate to the vehicle controller 82 which stages of the pre-planned route should operate as electric-only EV mode and which stages of the pre-planned route should operate in battery save BS mode (engine-on). The ECM 88, TCM 90 and/or the BECM 92 are capable of such operation during the route in response to a signal from the navigation system 84 that indicates that the electrified vehicle 12 has reached a location in the route where a battery mode transition is to occur.

In another non-limiting embodiment, the vehicle controller 82 can control an autonomous vehicle based on a battery mode selected by the user in the manner described above. For example, the user can select when the autonomous vehicle is to operate in EV mode and when to operate in BS mode along a planned route to improve fuel economy, quietness, and eliminate unexpected over-reactions from the autonomous vehicle (e.g. prevent the autonomous hybrid vehicle from starting the engine unexpectedly when only a short distance from home).

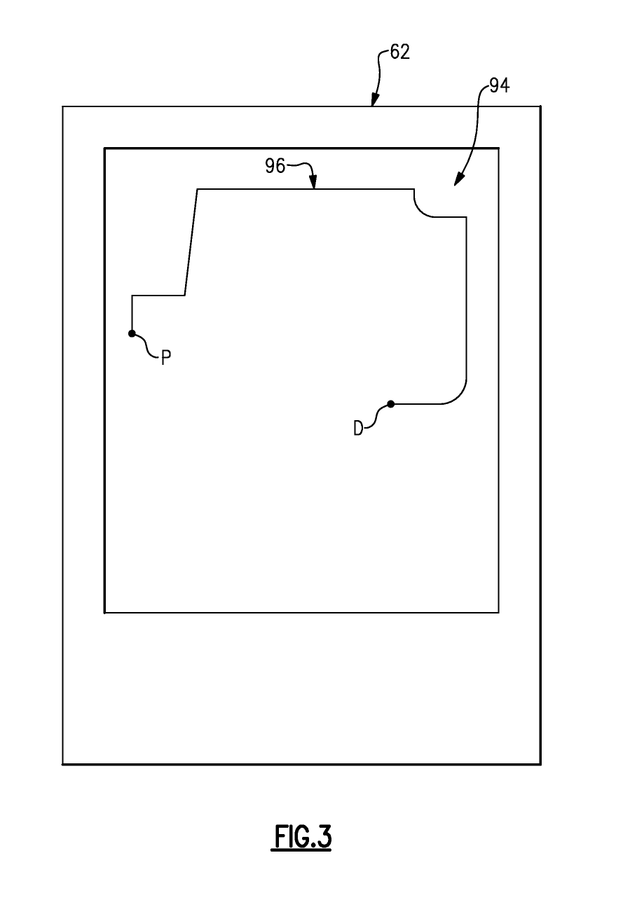

FIGS. 3-9 schematically illustrate a method of controlling a vehicle using the vehicle system 60 described above in FIG. 2. It should be understood that the exemplary method could include fewer or additional steps than are recited below. In addition, the inventive method of this disclosure is not limited to the exact order and/or sequence described in the embodiments detailed herein.

Referring to FIG. 3, a user (i.e., owner/operator of the electrified vehicle 12) can access a map 94 that is displayed on the computing device 62 via an APP, website, etc. This will typically be done at a location separate from the electrified vehicle 12 and prior to its operation. In one non-limiting embodiment, the user may access the map 94 at home prior to operating the electrified vehicle 12. However, the map 94 can be accessed at any location where the computing device 62 is capable of accessing the APP, website, etc.

The user may select a starting point P and a destination D on the map 94. The starting point P and the destination D are used to establish a pre-planned route 96 over which the user wishes to operate the electrified vehicle 12. The user may be provided with numerous options for selecting the route 96, including but not limited to fastest route, shortest route, best fuel economy route and/or historical route. In one non-limiting embodiment, the historical route is based on prior routes the user has planned/traveled. Such historical routes may be saved on the computing device 62, the APP, the website, etc. The aforementioned routes are provided only as non-limiting examples. Once a route option has been selected, the route 96 is automatically drawn on the map 94.

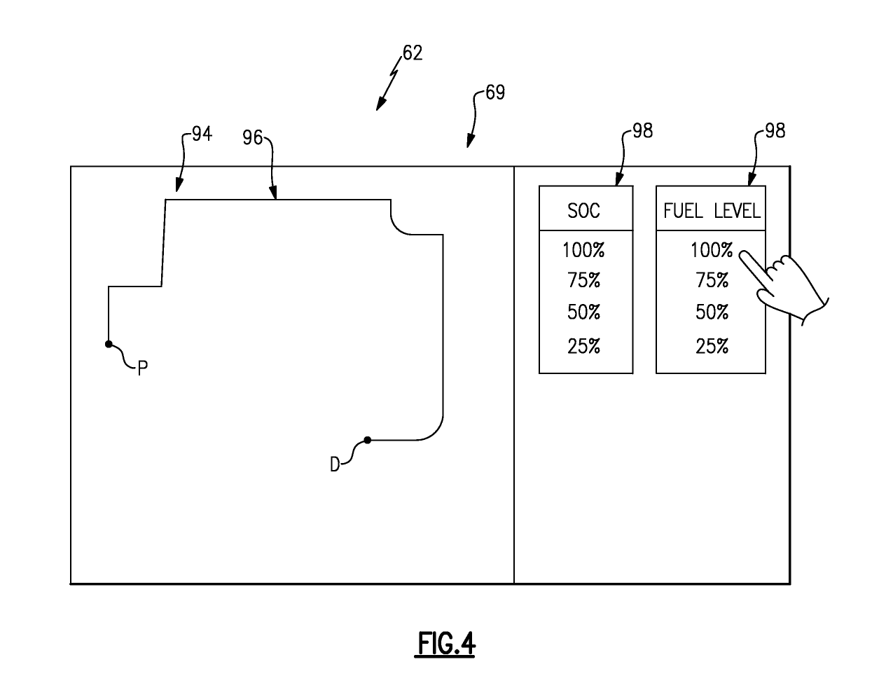

Next, as illustrated by FIG. 4, the user may enter an estimated state of charge (SOC) of the battery 50 as well as an estimated fuel level of the electrified vehicle 12. The SOC and the fuel level may be entered in data fields 98 located near the map 94 on the display 69 of the computing device 62. In one non-limiting embodiment, the data fields 98 are drop-down menus that allow the user to select an estimated SOC and fuel level, such as 100%, 75%, 50% or 25%, or any other values. In another embodiment, the user may manually enter the SOC and fuel levels into the data fields 98. Other types of data fields may also be presented to the user. The SOC and fuel level may default to 100%, or full, if not specifically entered by the user.

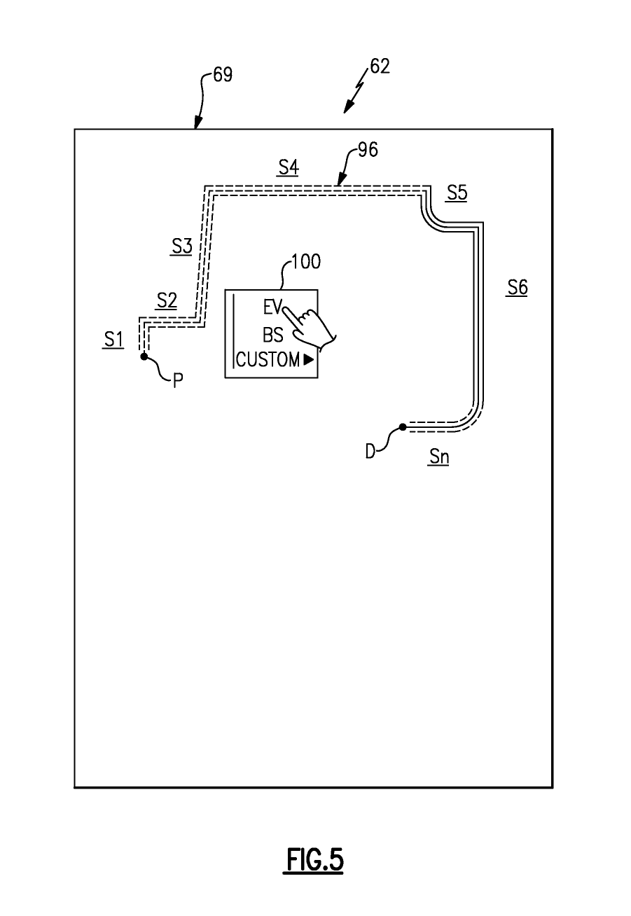

After the SOC and fuel levels have been entered, the user may select a battery mode for operating the electrified vehicle 12 during each stage S1 through Sn of the route 96. This is illustrated by FIG. 5. The stages S1 through Sn correspond to the various roads, streets or highways that will be traveled during the route 96. In one non-limiting embodiment, the user may select either an electric-only EV mode (indicated by dashed lines) or a battery save BS mode (indicated by solid lines) for operating the electrified vehicle 12 during each stage S1 through Sn.

Other modes may also be used within the scope of this disclosure. For example, the user could additionally be given the option to select a battery charge mode which includes charging the battery to maximize the distance available for EV mode operation. This would allow the user to achieve a desired range even where he/she has forgotten to fully charge the electrified vehicle 12.

The battery mode selection may be performed in a variety of manners, including but not limited to, right-clicking (or tapping if display 69 of the computing device 62 is a touch screen display) on a portion of the route 96 to select either EV or BS. A selection field 100 may be presented to allow the user to select the points of transition between battery modes at any stage S1 to Sn of the route 96. Other options may also be presented to the user (indicated by “CUSTOM” in selection field 100), including but not limited to, “always EV when speed limit is less than 25 mph,” “always BS on highways,” and/or “revert to standard battery operation.” Yet another potential option is for the user to select “BS only when EV has depleted.” In view of these non-limiting examples, the user has complete control over when and where the points of transition between EV and BS occur during the route 96.

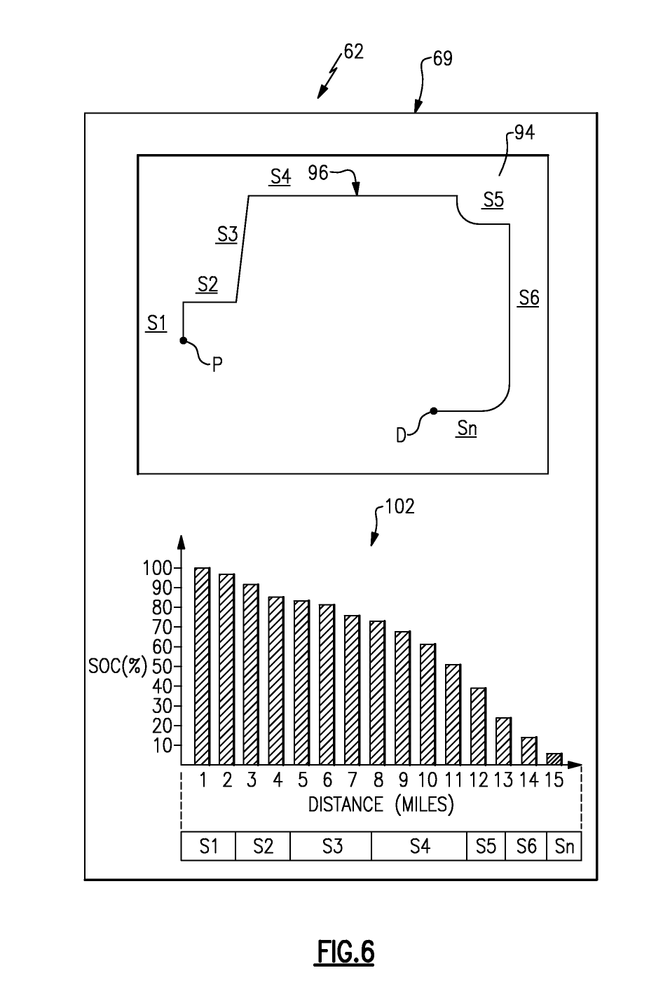

The resulting effect on SOC during each stage S1 to Sn may be presented to the user on the computing device 62 in a number of ways subsequent to selecting the battery mode transition points. In a first embodiment illustrated in FIG. 6, the SOC level is presented in a graph 102 near the map 94 that plots SOC (as a percentage %) versus distance (in miles). Each stage S1 to Sn may also be shown on the horizontal axis to demonstrate to the user the distances associated with each stage S1 to Sn. For example, in this embodiment, the first stage S1 transitions to the second stage S2 at approximately the 2^{nd} mile of the route 96.

By displaying the SOC information in this manner, the user can determine whether their desired battery modes are feasible or practical in the manner previously selected along the route 96. For example, the graph 102 may be studied by the user to determine whether sufficient battery power is available for utilizing the selected battery modes along the route 96, or whether the battery mode or the route 96 itself will need to be modified. The user can then change battery mode transition points associated with any stage S1 to Sn of the route 96 in the manner described above with reference to FIG. 5.

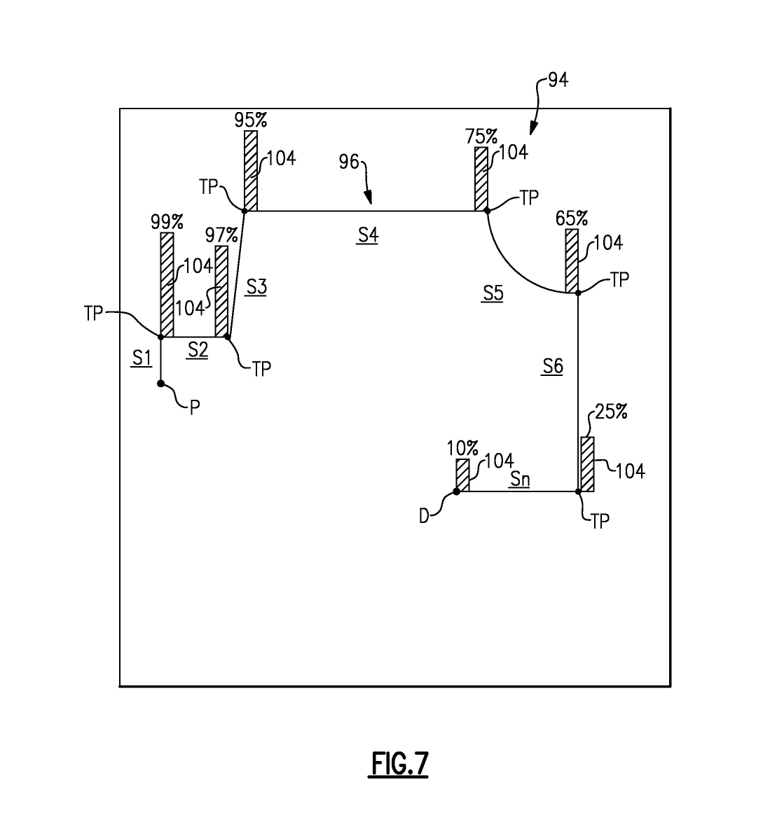

A second embodiment for displaying the SOC during each stage S1 to Sn is illustrated in FIG. 7. In this embodiment, the SOC is displayed as a bar 104 that rises above each transition point TP between the stages S1 to Sn of the route 96. The height and color of the bars 104 may be in proportion to the anticipated SOC at that specific point of the route 96. In this way, the bar 104 associated with the first stage S1 is presented larger and in a different color (for example, in green) than the bar 104 associated with the transition point TP between the sixth stage S6 and the final stage Sn, which could be shown much smaller and in red (for example) to indicate a low SOC to the user. In addition, the user could click on any point of any stage S1 to Sn to generate a bar 104 indicating SOC.

Additional non-limiting embodiments of the manner in which the SOC can be presented to the user include presenting a numerical display of the SOC along the route 96, presenting a relatively thicker line for greater SOC's and a relatively thinner line for lower SOC's, or presenting different colored lines for indicating high and low SOC's, respectively.

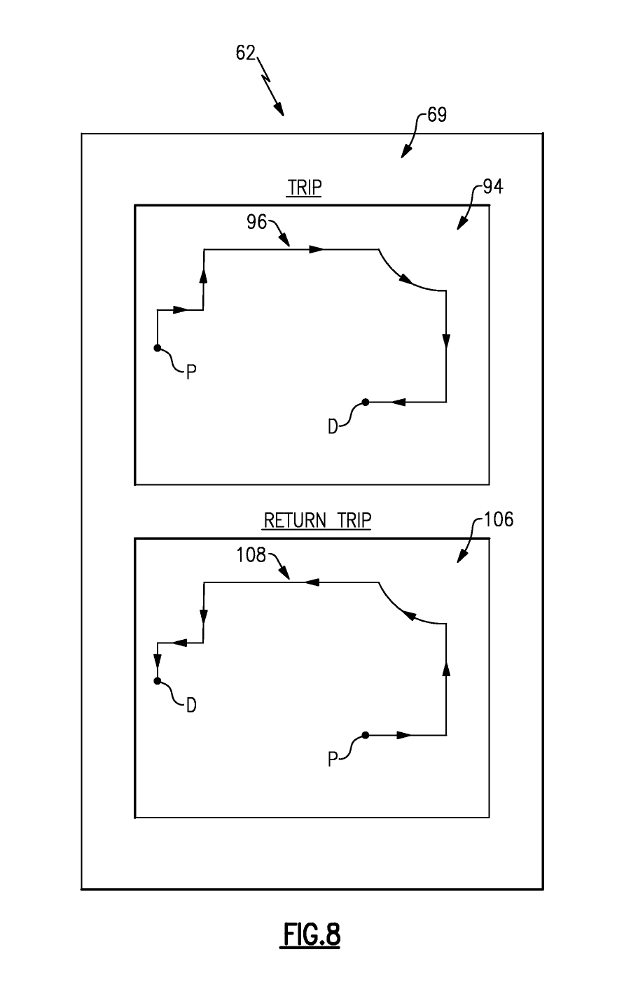

Referring to FIG. 8, a return trip map 106 can be automatically generated and displayed below or otherwise next to the map 94 after the route 96 has been planned in the manner detailed above. Projected SOC and fuel level information from the route 96 can be used to plan a return route 108. Alternatively, the user may specify different starting and destination points to plan the return route 108. The return route 108 can plan for cases with or without battery charging at the original destination D of the route 96. Although not shown in FIG. 8, a display of SOC during the return route 108 may also be presented to the user.

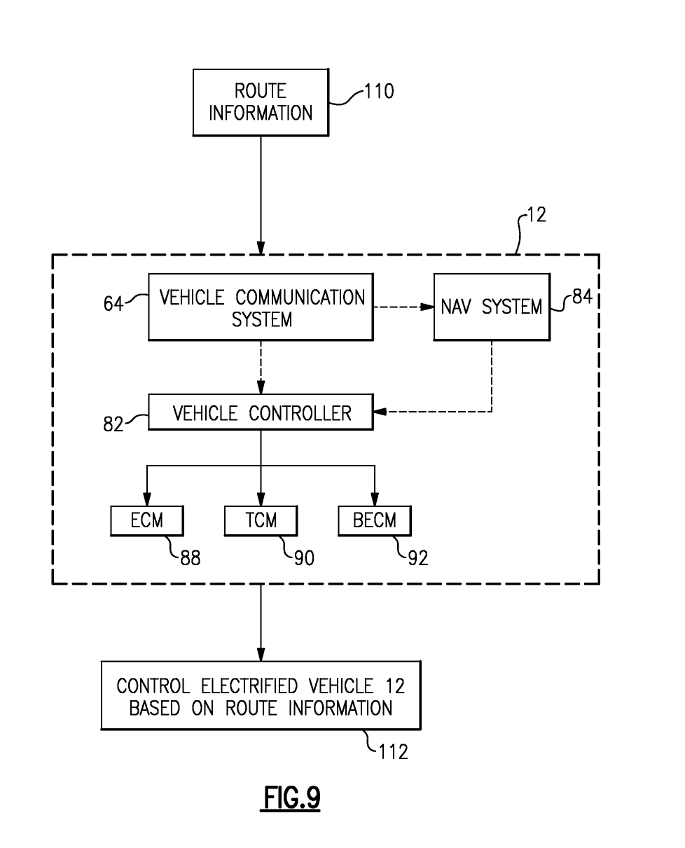

Finally, as illustrated in FIG. 9, route information 110 entered onto the computing device 62 may be downloaded onto the electrified vehicle 12. The route information can be downloaded onto the electrified vehicle 12 in a manner similar to that described in FIG. 2. For example, the vehicle communication system 64 receives the route information 110, including battery mode transition points, and communicates the information to the navigation system 84. The navigation system 84 communicates via the vehicle controller 82 with the ECM 88, TCM 90 and/or the BECM 92 when the electrified vehicle 12 is at a location specified in the pre-planned route for commanding a battery mode transition. In other words, as schematically shown at 112, operation of the electrified vehicle 12 is controlled based on the route information 110 along the pre-planned route and according to the selected battery modes by the exemplary vehicle system 60.

The electrified vehicle 12 may optionally be tracked during operation along the route 96. For example, the vehicle system 60 may track where the electrified vehicle 12 goes as well as SOC and fuel level information. This information can be uploaded via the cloud 74 and accessed by the user on the computing device 62 for use in planning subsequent routes.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A method, comprising:
pre-planning a route of a vehicle on a computing device separate from the vehicle including selecting a battery mode for operating the vehicle during each stage of the route and displaying a battery state of charge for each stage of the route; and
controlling the vehicle based on route information associated with the pre-planned route.

2. The method as recited in claim 1, wherein the step of pre-planning includes accessing a software application or a website on the computing device.

3. The method as recited in claim 1, wherein the step of selecting the battery mode includes:
selecting an electric only EV mode for a first stage of the route;
selecting a battery saver BS mode for a second stage of the route; and
selecting a battery charge mode for a third stage of the route.

4. The method as recited in claim 1, wherein the step of displaying the battery state of charge includes generating a graph that plots the battery state of charge versus distance.

5. The method as recited in claim 1, wherein the step of displaying the battery state of charge includes displaying a bar that rises above each stage of the route, the bar numerically indicating the battery state of charge.

6. The method as recited in claim 1, wherein the step of pre-planning the route includes:
displaying a map; and
selecting a starting point and a destination on the map for creating the pre-planned route.

7. The method as recited in claim 1, comprising entering an initial battery state of charge and fuel level of the vehicle prior to the step of selecting the battery mode.

8. The method as recited in claim 1, comprising the step of automatically generating a return route based on the pre-planned route created during the step of pre-planning.

9. The method as recited in claim 1, comprising the step of adjusting the battery mode associated with each stage of the route in response to the step of displaying the battery state of charge indicating insufficient charge to complete the route.

10. The method as recited in claim 1, wherein the vehicle is an autonomously driven electrified vehicle.

11. A method, comprising:
pre-planning a route of a vehicle;
selecting battery mode transition points along each stage of the route;
automatically generating a return route of the vehicle after the steps of pre-planning and selecting; and
controlling the vehicle during the route and the return route based on route information that includes the battery mode transition points.

12. The method as recited in claim 11, comprising entering an initial battery state of charge and fuel level of the vehicle prior to the step of selecting.

13. The method as recited in claim 11, wherein the step of selecting includes choosing between an electric only EV mode, a battery saver BS mode and a custom mode for each stage of the route.

14. The method as recited in claim 11, comprising the step of displaying a battery state of charge for each stage of the route and the return route.

15. The method as recited in claim 11, comprising the step of downloading the route information onto the vehicle prior to the step of controlling.

16. A vehicle system, comprising:
a computing device separate from a vehicle and configured to select battery mode transition points and display a battery state of charge for each stage of a route;
a vehicle communication system located on-board said vehicle and configured to download route information that includes said battery mode transition points from said computing device; and
a vehicle controller configured to operate said vehicle based on said route information.

17. The system as recited in claim 16, wherein said computing device is a smart device or a personal computer.

18. The system as recited in claim 16, wherein said vehicle communication system includes a transceiver for communicating with said computing device.

19. The system as recited in claim 16, comprising a navigation system in communication with said vehicle communication system.

20. The system as recited in claim 16, wherein the vehicle system is part of an autonomously driven electrified vehicle.
